(19) United States
(12) Patent Application Publication
(10) Pub. No.: US 2007/0099007 A1
(43) Pub. Date: May 3, 2007

(54) Use of hydrophilic (co) polymers in crosslinkable aqueous silicone emulsions

(76) Inventors: Jean-Paul Benayoun, Lyon (FR); Christian Mirou, Lyon (FR); Charles Phan, Aubervilliers (FR); Kenneth Wong, Paris (FR)

Correspondence Address: JAMES C. LYDON, 100 DAINGERFIELD ROAD, SUITE 100, ALEXANDRIA, VA, 22314, US

(21) Appl. No.: 11/521,359

(22) Filed: Sep. 15, 2006

Related U.S. Application Data
(63) Continuation of application No. 10/989,637, filed on Nov. 17, 2004, now abandoned.
Application No. 10/989,637 is a continuation of application No. 10/182,815, filed on Oct. 7, 2002, now abandoned.

(30) Foreign Application Priority Data
Feb. 15, 2000 (FR) 00/01866

(51) Int. Cl. B32B 27/18; B32B 27/00; B32B 37/00

(52) U.S. Cl. 428/447

(57) ABSTRACT

An aqueous crosslinkable silicone emulsion suitable for preparing a release coating on fibrous supports. The emulsion contains a polyorganosiloxane having Si-vinyl units and a polysiloxane having SiH units, crosslinkable by polyaddition in the presence of a platinum catalyst, together with at least one hydrophilic stabilizing (co)polymer having a molar mass greater or equal to 10,000 g/mol. The stabilizing (co)polymer improves the emulsion's coalescence stability under shear, improves the regularity and homogeneity of a coating of the emulsion on both surfaces of a paper support, and reduces the emulsion's tendency to foam.

### TECHNICAL FIELD

The field of the invention is that of crosslinkable or crosslinked silicone compositions capable of being used in particular for forming a water-repellent and antiadhesive coating or film for a fibrous or nonfibrous substrate, for example made of paper or the like, or alternatively made of natural or synthetic polymer.

More specifically, the invention relates to aqueous silicone dispersions or emulsions of the type of that comprising:
functionalized polyorganosiloxanes (POS) carrying, on the same molecule or a different molecule:
   -a- Si—H and Si-EU units with EU representing a group comprising at least one ethylenic unsaturation, preferably a vinyl unsaturation; the Si—H units being capable of reacting with the Si-EU units by polyaddition;
   -b- and/or Si—OR^{o} units (with R^{o} representing a C₁-C₆ alkyl) capable of reacting with one another by polycondensation;
   -c- and/or Si—OR^{o} units (with R^{o} representing a C₁-C₆ alkyl) and Si—H units capable of reacting with one another by dehydrogenation/condensation;
   -d- reactive units capable of reacting with one another by the cationic and/or radical route (e.g. acrylate or epoxy units);
a catalyst -C- appropriate for the reactions targeted above, respectively: -a- a metallic catalyst, preferably a platinum catalyst, -b- and -c- a metallic catalyst, preferably a stannous catalyst, -d- a cationic and/or radical photoinitiator (e.g. onium salts);
other additives (fillers, accelerators, inhibitors, pigments, surfactants, and the like).

The invention also relates to the preparation of aqueous silicone emulsions of this type.

The present document is also targeted at processes for the manufacture, starting from the emulsion targeted above, of articles made of crosslinked silicone, in particular coatings, e.g. water-repellent and/or antiadhesive coatings, for fibrous or nonfibrous substrates (paper).

### PRIOR ART

Polyorganosiloxanes are known for their ability to render surfaces of various substrates antiadhesive (e.g. paper, cloth, polymer film or others). Antiadhesive treatments are easy to carry out with silicones as the latter can be provided in the form of a crosslinkable liquid polymer, solution or emulsion which are easy to apply to and spread over substrates at an industrial rate and on an industrial scale. This is why silicone compositions are used, for example, as a mold-release agent, in particular in the manufacture of tires and in the injection of plastics, or alternatively for the coating of metal molds used in the pastry industry or of racks in baker's ovens, or finally for the preparation of adhesive-protective paper (label, decorative paper), of paper inserts for the handling of sticky masses (laminate, raw rubber) or of antiadhesive paper for the baking of pastries.

By way of illustration, it may be indicated that applications or patents U.S. Pat. No. 4,347,346, EP-A-0 219 720, EP-A-0 454 130 and EP-A-0 523 660 disclose polyorganosiloxanes intended to be used in a paper antiadhesive application.

The silicone compositions according to the prior art targeted hereinabove are employed in this field of paper antiadhesiveness in the form of emulsion slips (or coating slips) which serve to coat substrates with films which are subsequently crosslinked under thermal activation and/or under radiation (UV, electron beam) to form the water-repellent and antiadhesive coating.

The aqueous silicone emulsion systems more particularly concerned with in the context of the present account are those comprising polyorganosiloxanes (POSs) with Si—H units and POSs with Si-vinyl units. These systems conventionally polymerize by platinum catalysis according to an Si—H/Si-Vi polyaddition mechanism (also known as hydrosilylation).

Apart from the Si—H POSs and the Si-Vi POSs and the platinum catalyst, these emulsions can comprise one or more water-soluble constituents, such as hydroxyethylcellulose, starch, poly(vinyl alcohol), and the like, having in particular an emulsifying, thickening and stabilizing role but also the role of promoting two conflicting effects, namely: antiadhesiveness and printability.

Surfactants can also participate in the composition of such emulsions.

Aqueous silicone emulsion slips of the state of the art have suffered, for some time, from a degree of chemical instability which is reflected by the production of undesirable (chemical) foam and gel.

These gels originate from a premature addition reaction between Si-Vi units and Si—H units, which result in the bridging of silicon atoms, leading to a degree of increase in the viscosity of the medium. The foams, for their part, result from side dehydrogenation/condensation reaction between the Si—H groups of the POSs present in the slip and hydroxyl groups which are contributed by the water and other additives of these emulsions.

The known aqueous emulsion slips furthermore had another major disadvantage, namely a physical instability, in combination with the chemical instability mentioned hereinabove. This is because, as soon as the emulsion is subjected to shearing (stirring), which is in particular the case when emulsion circulates in industrial coating equipment (in particular in the pumps or the coating heads), a phenomenon of coalescence of the droplets of dispersed silicone phase occurs. Gelling consequently occurs, resulting in a loss in reactivity and a poorer quality of the coating, in particular with regard to antiadhesiveness. This phenomenon is aggravated by the fact that the temperature of the emulsion can increase as it circulates in industrial coating equipment. This problem of coalescence under shearing is all the more acute for engraved cylinder coating systems. This is because, as soon as, because of the coalescence, a certain particle size is exceeded for the dispersed phase, the latter no longer fills or fills poorly the rough regions engraved on the coating roll. Under these conditions, it is clear that the couching is of poorer quality.

It is therefore important to combat this premature coalescence under shearing as it is harmful to the couching, to the kinetics of crosslinking and thus, in the end, to the quality of the antiadhesive coating deposited on the substrate, for example made of paper.

The Applicant Company has succeeded in solving the problem of the chemical instability (gel and foam) and in partially solving the problem of physical instability (coalescence under shearing) in slips of aqueous silicone emulsions intended to be crosslinked to form antiadhesive coatings, e.g. for paper, by providing for the use, as additive in these emulsions, of an agent for fixing and maintaining the pH between 6 and 8, this agent advantageously being a buffer system, such as NaHCO₃. This invention is disclosed in PCT International Application WO PCT/FR98/02858 (WO 99/35181).

The aqueous silicone emulsions according to this PCT application remain capable of improvement as regards their resistance to coalescence under shearing.

In addition, as regards their properties in being converted to an antiadhesive crosslinked silicone coating on a flexible substrate, for example made of paper, it was able to be observed that a need remains with regard to the improvement of the homogeneity and of the evenness of the deposition of the emulsion on the two faces of a flexible substrate, for example made of paper. The evenness of the depositions of silicone on both faces of the substrate is desired as it facilitates the adjusting of the coating heads and makes it possible to adjust, a minima and without risk, the deposition of the silicone layer.

Furthermore, it is also an aim to decrease the silicone deposits on the rollers of the coating equipment. These residual silicone deposits present maintenance problems and interfere with the satisfactory preparation of the depositions of coatings, in particular in the case where the coating equipment comprises drying rollers.

Progress therefore remains to be made with regard to the following aspects:
coalescence under shearing,
evenness of the deposition over the two faces of the substrate,
reduction in the residual silicone deposits on the rollers of the coating equipment,
and maintenance, indeed even improvement, of the antifoaming properties, which can extend as far as the suppression of the untimely formation of foams.

Furthermore, aqueous silicone emulsions which are precursors of antiadhesive coatings are known through U.S. Pat. Nos. 5,108,782 and 5,229,212. These emulsions comprise a dispersed silicone phase based on polydimethylsiloxane carrying Si—H units, polydimethylsiloxane comprising Si-Vinyl units and a catalyst based on a platinum complex, while the homogeneous aqueous phase of these emulsions comprises a water-dispersible or water-soluble polymer thickening agent, namely a polyoxyethylene (commercial name: “Polyox WSR-301”, Union Carbide). These emulsions comprise, on a dry basis, 94% by weight of silicone, 4.5% by weight of catalyzing emulsion and 1.5% by weight of polyoxyethylene.

Like all the thickeners conventionally employed in aqueous silicone emulsions of this type, the polyoxy-ethylene is a thickener with the purpose of increasing the content of the silicone on the surface of the substrate by preventing it from penetrating inside the latter. The thickeners according to these US patents act by increasing the viscosity of the emulsion and by their ability to trap water.

The hydrophilic polymer thickening agent preferably used in these prior United States patents is included within a range of molecular weights from 1×10⁵ g/mol to 10×10⁶ g/mol. In addition, when it is polyethylene oxide, the preferred molar mass is then between 5×10⁵ and 1×10⁶ g/mol.

In addition to polyoxyethylene, the thickening agent according to these United States patents can be chosen from polyoxypropylenes, propylene/ethylene oxide copolymers or polyacrylamides.

Furthermore, it should be noted that these prior United States patents make no reference to the improvement:
in the stability toward coalescence under shearing,
in the evenness and in the homogeneity of the depositions of silicone emulsions over the two faces of a flexible substrate, for example made of paper,
   no more than to the reduction in the silicone deposits on the rollers of the coating equipment after application of an aqueous silicone emulsion film,
   and even less to the reduction in the undesirable formation of foams.

### BRIEF ACCOUNT OF THE INVENTION

In such a state of the art, the Applicant Company set itself the essential objective of developing a novel additive for an aqueous silicone emulsion:
for the purpose of improving their stability toward coalescence under shearing,
and/or for the purpose of improving the evenness and the homogeneity of the deposition of a silicone emulsion film over the two faces of a flexible substrate, for example made of paper,
and/or for the purpose of limiting the residual deposits of silicone on the rollers of the coating equipment, after deposition of the silicone emulsion film,
and/or for the purpose of reducing, indeed even eliminating, the formation of foams.

An essential objective of the invention is to provide a process for the preparation of the aqueous silicone emulsions mentioned above.

Another objective of the invention is to provide flexible substrates, for example made of paper, which exhibit an antiadhesive crosslinked silicone coating of good quality with regard to couching and antiadhesiveness;

this coating:

furthermore forming an even deposit on both sides of the flexible substrate, for example made of paper,
not resulting in a silicone deposit on the rollers of the coating equipment,
and offering good properties of gloss and of retention at the surface of the substrate.

These objectives, among others, are achieved by the present invention, which provides, first of all, for the use of at least one stabilizing hydrophilic (co)polymer with a molar mass Mw≧1×10⁵ g/mol, preferably Mw≧5×10⁵ g/mol:
for improving the stability toward coalescence under shearing of aqueous silicone emulsions capable of crosslinking to form antiadhesive coatings on flexible substrates, for example made of paper,
and/or for improving the evenness and the homogeneity of the deposition of crosslinkable aqueous silicone emulsions on the two faces of flexible substrates, for example made of paper,
and/or for reducing the deposits of aqueous silicone emulsions capable of crosslinking to form antiadhesive coatings on flexible substrates, for example made of paper,
and/or for limiting, indeed even eliminating, the tendency to foam shown by the aqueous silicone emulsions capable of crosslinking to form antiadhesive coatings on flexible substrates, for example made of paper.

(Mw: average molar mass).

Thus, by virtue of the use of this additive, aqueous silicone emulsions, in particular for forming anti-adhesive coatings on flexible substrates (paper), are no longer subject to the phenomenon of coalescence under shearing. They retain their properties at the level of the application, namely: they adhere perfectly to the substrate, for example made of paper, they are easily and correctly formed into a film and their crosslinking takes place rapidly and satisfactorily. Thus, these emulsions in which use is made, in accordance with the invention, of a carefully selected hydrophilic stabilizer are capable of forming high-quality antiadhesive layers.

The improvement in the stability under shearing (non-coalescence) which the additive employed according to the invention provides to the aqueous silicone emulsions is based on the contribution of a specific rheological property to the continuous phase. The property concerned is the elongational viscosity ηₑₗ. Thus, in accordance with the invention, macromolecules which promote elongational viscosity ηₑₗ are selected. The hydrophilic polymers used seem to convert the conditions of turbulence which the emulsion experiences when it is stirred (under shearing) to laminar conditions. This makes it possible to limit the impacts between the particles of disperse phase and thus to slow down the prohibited coalescence.

### DETAILED ACCOUNT OF THE INVENTION

According to preferred characteristics of the invention, the stabilizer is chosen from the group of hydrophilic (co)polymers consisting of:
-a- aliphatic polyethers obtained from monomers comprising at least one linear or branched alkylene residue having from 1 to 6 carbon atoms, preferably:
   poly(methylene oxide)
   poly(ethylene oxide)
   poly(propylene oxide)
   copoly(methylene oxide) (propylene oxide)
   polyoxethane
   copoly(methylene oxide)(propylene oxide);
-b- (co)polyacrylamides obtained by copolymerization of acrylamide with one or more copolymerizable comonomer(s);
-c- polysaccharides:
   natural polysaccharides of animal origin, such as, in particular, chitosan and chitin,
   natural polysaccharides of vegetable origin:
      such as, in particular, carrageenans, alginates, gum arabic, guar gum, locust bean gum, tara gum, cassia gum, konjac gum or mannan gum; guars, alginates or locust bean gums being more especially valued,
      and/or starch and its derivatives and/or cellulose and its derivatives, carboxy-methylcellulose, methylcellulose, ethyl-cellulose, hydroxymethylcellulose, cyanoethylated starch and carboxy-methylated starch being particularly selected;
   and/or those of bacterial origin (biogums), in particular those obtained by fermentation of a carbohydrate under the action of a microorganism, xanthan gums obtained by fermentation under microorganisms belonging to the Xanthomonas genus,
-d- polyacrylates: 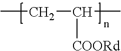
Rd representing a linear or branched C₁-C₁₂ alkyl or a C₅-C₆ cycloalkyl.

These carefully added polymer additives make it possible to increase the elongational viscosity, which limits or eliminates the turbulence and reduces the resistance encountered by the particles of silicone dispersed phase in the emulsion.

The additives a, b, c and d, which are promoters of elongational viscosity, are long and flexible hydrophilic macromolecules of high molecular weight Mw. In practice, they are polymers of high molecular mass Mw or alternatively giant micelles.

As regards the molecular mass Mw, that of the stabilizers a or b employed in the use according to the invention is defined as follows (in g/mol):
more preferably still Mw≧1×10⁶
more especially still Mw≧3×10⁶
and in practice . . . 20×10⁶≧Mw≧4×10⁶.

Furthermore, these stabilizers of a type, (co)poly(alkylene oxide), or b type, (co)poly-acrylamide, are employed at a concentration Cs, expressed as weight % with respect to the mass of POS in the emulsion, such that:
0.1≦Cs≦5
preferably 0.5≦Cs≦2.

When the stabilizer is a polysaccharide of c type, it is preferable for it to be a polymer with an Mw (in g/mol) such that:
more preferably still Mw≧1×10⁵
more especially still Mw≧3×10⁵
and in practice 20×10⁶≧Mw≧5×10⁵.

In such a scenario, the concentration Cs of stabilizer -c- in the emulsion is defined as follows (expressed as weight % with respect to the mass of the POSs in the emulsion):
0.05≦Cs≦5
preferably 0.1≦Cs≦2.

Mention may be made, as examples of stabilizer of -a- type, of:
Poly(ethylene oxide)s of formula a1: 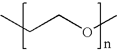
Poly(propylene oxide)s of formula a2:

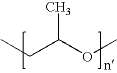

In the above formulae a1 and a2, n and n′ are chosen so as to obtain the molar masses defined above.

Mention may be made, as examples of polyacrylamide, of those of formula b:

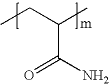

m is chosen so as to obtain the molar masses defined above.

It is to the credit of the Applicant Company to have determined a reliable and reproducible selection criterion for the selection of the stabilizer promoting elongational viscosity. Thus, this stabilizer is chosen so that the emulsion has the following particle size characteristics regarding the dispersed silicone phase:
D₅₀≦7 μm, preferably ≦3 μm
D₉₀≦20 μm, preferably ≦10 μm
after 4 hours in a T stability test and for a starting particle size such that:
D₅₀≦0.7 μm
D₉₀≦1.5 μm
D₅₀=diameter below which lies at least 50% of the population of particles.
D₉₀=diameter below which lies at least 90% of the population of particles.

More specifically, within the meaning of the invention, the parameter D₅₀ (or D₉₀) is the median size of the particle size distribution. It can be determined on the cumulative particle size distribution graph, obtained by one of the analytical techniques mentioned below, by determining the size corresponding to the cumulative total of 50% (or of 90%) of the population of the particles. In concrete terms, this particle size parameter D₅₀ (or D₉₀) corresponds to the mean maximum size of at least 50% (or 90%) of the mass of particles under consideration; a D₅₀ (or D₉₀) of 10 μm indicates that 50% (or 90%) of the particles have a size of less than 10 μn. The particle size measurements can be carried out by conventional techniques, such as sedimentation, laser diffraction (for example, Coulter® LSI30), optical microscopy coupled to image analysis, and the like.

The T stability test is defined below. Use is made of a glass beaker with a diameter of 7.5 cm and a length of 13 cm, thermostatically controlled at 30° C. The paddle used is a propeller paddle (3 blades) with a diameter of 3 cm and is situated at a distance of 2 cm from the bottom of the beaker. The stirrer speed is 2 000 rpm.

Every hour, a sample is withdrawn and the size of the emulsion is measured on a Horiba particle sizer.

This T stability test demonstrates the absence of coalescence under shearing of the aqueous silicone emulsion to which the stabilizer or stabilizers selected has/have been added.

The use in accordance with the invention of said stabilizer can also have the effect of improving the evenness and homogeneity of the deposition of emulsion as a layer on the two faces of a paper substrate. By virtue of the stabilizer, the deposition of emulsion as a layer is virtually identical on both faces of the paper. The evenness and homogeneity of the silicone deposits are measured in grams per m² according to the X-ray fluorescence method on a device of the Oxford X-Ray 300 type on the two faces of the paper. These deposits are produced by coating, on equipment of size press type, a nonporous vegetable parchment substrate. Crosslinking is carried out at 130° C.

Another effect desired through the use of a hydrophilic polymer stabilizer is the reduction of the silicone deposits on the rollers of the coating equipment (“reduction in the dust”). This reduction is evaluated visually. It is the same as regards the limitation, indeed even the elimination, of the formation of undesirable foams. In this respect, there is reason to note that this advantageous function of the stabilizer used in accordance with the invention makes it possible to avoid or to limit recourse to an antifoaming agent.

Insofar as the stabilizer used in accordance with the invention also limits the penetration of the silicone into the flexible substrate, for example paper, it is possible to envisage reducing the solids content of the aqueous silicone emulsions employed in coating to form paper and adhesive coatings. This results in a significant saving, which constitutes an important advantage of the invention.

The emulsions concerned by the use in accordance with the invention are of the type of those comprising:
-A- at least one polyorganosiloxane (POS) carrying Si-alkenyl, preferably Si-Vi, cross-linking units;
-B- at least one POS carrying Si—H crosslinking units;
-AB- and/or at least one POS carrying Si-alkenyl and Si—H units;
-C- at least one polyaddition catalyst, preferably based on platinum;
-D- at least one stabilizer as defined above;
-E- at least one crosslinking inhibitor, preferably chosen from acetylenic alcohols;
-F- and/or at least one agent for fixing and maintaining the pH (preferably a buffer and more preferably still NaHCO₃);
-G- optionally at least one surfactant;
-H- optionally at least one poly(vinyl alcohol) PVA as defined below;
-I- optionally at least one other additive chosen from bactericides and/or antigelling agents and/or wetting agents and/or antifoaming agents and/or fillers and/or synthetic latices and/or colorants and/or acidifying agents.

Use is preferably made of at least one POS A of Si-alkenyl type, for example Si-Vi, and at least one POS B of Si—H type.

The POS A is, by weight, one of the essential constituents of the emulsion.

This POS A is advantageously a product comprising units of formula:

$${W}_{a} {Z}_{b} {SiO}_{\frac{4 - ( a + b )}{2}} \qquad ( A .1 )$$

in which:
W is an alkenyl group, preferably a vinyl or allyl group,
Z is a monovalent-hydrocarbonaceous group which has no unfavorable effect on the activity of the catalyst and which is preferably chosen from alkyl groups having from 1 to 8 carbon atoms inclusive, advantageously from methyl, ethyl, propyl and 3,3,3-trifluoropropyl groups, and also from aryl groups and, advantageously, from xylyl and totyl and phenyl radicals,
a is 1 or 2, b is 0, 1 or 2 and a +b is between 1 and 3,
optionally at least a portion of the other units are units of average formula:

$${Z}_{c} {SiO}_{\frac{4 - ( c )}{2}} \qquad ( A .2 )$$

in which Z has the same meaning as hereinabove and c has a value of between 0 and 3, for example between 1 and 3.

Z is generally chosen from methyl, ethyl and phenyl radicals, 60 mol % at least of the Z radicals being methyl radicals.

It is advantageous for this polydiorganosiloxane to have a viscosity (at 25° C.) at least equal to 10 mPa·s, preferably of between 50 and 1 000 mPa·s.

All viscosities concerned with in the present account correspond to a so-called “Newtonian” dynamic viscosity quantity at 25° C., that is to say the dynamic viscosity which is measured, in a way known per se, at a shear rate gradient which is sufficiently low for the viscosity measured to be independent of the rate gradient.

The polyorganosiloxane A can be formed solely of units of formula (A.1) or can additionally comprise units of formula (A.2). Likewise, it can exhibit a linear, branched, cyclic or network structure. Its degree of polymerization is preferably between 2 and 5 000.

Examples of siloxyl units of formula (A.1) are the vinyldimethylsiloxane unit, the vinylphenyl-methylsiloxane unit and the vinylsiloxane unit.

Examples of siloxyl units of formula (A.2) are the SiO_{4/2}, dimethylsiloxane, methylphenylsiloxane, diphenylsiloxane, methylsiloxane and phenylsiloxane units.

Examples of polyorganosiloxanes A are the dimethylpolysiloxanes with dimethylvinylsilyl ends, the methylvinyldimethylpolysiloxane copolymers with trimethylsilyl ends, the methylvinyldimethyl-polysiloxane copolymers with dimethylvinylsilyl ends and cyclic methylvinylpolysiloxanes.

The polyorganosiloxane B is preferably of the type of those comprising siloxyl units of formula:

$${H}_{d} {L}_{e} {SiO}_{\frac{4 - ( d + e )}{2}} \qquad ( B .1 )$$

in which:
L is a monovalent hydrocarbonaceous group which has no unfavorable effect on the activity of the catalyst and which is preferably chosen from alkyl groups having from 1 to 8 carbon atoms inclusive and, advantageously, from the methyl, ethyl, propyl and 3,3,3-trifluoropropyl groups, and also from aryl groups and, advantageously, from the xylyl and totyl and phenyl radicals,
d is 1 or 2, e is 0, 1 or 2 and d+e has a value of between 1 and 3,
optionally at least a portion of the other units being units of average formula:

$${L}_{g} {SiO}_{\frac{4 - g}{2}} \qquad ( B .2 )$$
in which L has the same meaning as hereinabove and g has a value of between 0 and 3.

The dynamic viscosity η_{d} (at 25° C.) of this polyorganosiloxane B≧than/to 5, preferably than/to 10 and more preferably still is between 20 and 1 000 mPa·s.

The polyorganosiloxane B can be formed solely of units of formula (II.1) or additionally comprises units of formula (B.2).

The polyorganosiloxane B can exhibit a linear, branched, cyclic or network structure. The degree of polymerization is greater than or equal to 2. More generally, it is less than 5 000.

Examples of units of formula (B.1) are:
H(CH₃)₂SiO_{1/2}, HCH₃SiO_{2/2}, H(C₆H₅)SiO_{2/2}

The examples of units of formula (B.2) are the same as those given above for the units of formula (A.2).

Examples of polyorganosiloxane B are:
dimethylpolysiloxanes with hydrodimethylsilyl ends, poly(dimethylsiloxane)(methylhydrosiloxy)(α,ω-dimethylhydrosiloxane),
copolymers with dimethyl-hydromethylpolysiloxane (dimethyl) units with trimethylsilyl ends,
copolymers with dimethyl-hydromethylpolysiloxane units with hydrodimethylsilyl ends,
hydromethylpolysiloxanes with trimethylsilyl ends,
cyclic hydromethylpolysiloxanes.

The polyaddition silicone composition bases can comprise only linear polyorganosiloxanes A and B, such as, for example, those disclosed in patents: U.S. Pat. No. 3,220,972, U.S. Pat. No. 3,697,473 and U.S. Pat. No. 4,340,709, or can at the same time comprise branched or networked polyorganosiloxanes A and B, such as, for example, those disclosed in patents: U.S. Pat. No. 3,284,406 and U.S. Pat. No. 3,434,366.

The catalysts C are also well known. Use is preferably made of platinum and rhodium compounds. Use may in particular be made of the complexes of platinum and of an organic product disclosed in patents U.S. Pat. No. 3,159,601, U.S. Pat. No. 3,159,602 and U.S. Pat. No. 3,220,972 and European patents EP-A-0 057 459, EP-A-0 188 978 and EP-A-0 190 530 and the complexes of platinum and of vinylated organosiloxanes disclosed in patents U.S. Pat. No. 3,419,593, U.S. Pat. No. 3,715,334, U.S. Pat. No. 3,377,432 and U.S. Pat. No. 3,814,730. The catalyst which is generally preferred is platinum. In this case, the amount by weight of catalyst C, calculated as weight of platinum metal, is generally between 2 and 400 ppm, preferably between 5 and 200 ppm, based on the total weight of the polyorganosiloxanes A and B.

The agent F for fixing and maintaining the pH is preferably a buffer system comprising HCO₃⁻/CO₃²⁻ and/or H₂PO₄⁻/HPO⁻²₄. Thus, in order to obtain the desired buffer effect, it will be advisable to introduce, in accordance with the invention, a HCO₃⁻ and/or H₂PO₄⁻ salt, such as, for example, NaHCO₃ and/or Na₂CO₃ and/or NaH₂PO₄ and/or Na₂HPO₄. It is obvious that any other salt with a different counteranion (e.g. K) could be suitable. In a particularly preferred way, use is in practice made of a buffer system composed of NaHCO₃ which is incorporated in the emulsion.

According to an alternative form, the buffer system can be a means which makes it possible to ensure regulation of the pH of the emulsion by monitoring the change in its pH and by correcting its variations by incorporation in the emulsion of appropriate amounts of at least one agent -F- which can be an acid or a base according to the direction in variation of the pH.

The acid or the base added to the emulsion according to requirements as agent -F- for the exogenous regulation of the pH can be inorganic or organic. It can also be a strong (or weak) acid salt or strong (or weak) base salt. Mention may be made, as examples of strong bases, of: triethanolamine, sodium hydroxide or potassium hydroxide.

The catalytic system of this silicone elastomer emulsion of polyaddition type advantageously comprises at least one stabilizer E or retardant for the addition reaction (crosslinking inhibitor) chosen from the following compounds:
polyorganosiloxanes, advantageously cyclic polyorganosiloxanes, which are substituted by at least one alkenyl, tetramethyl-vinyltetrasiloxane being particularly preferred,
pyridine,
organic phosphines and phosphites,
unsaturated amides,
alkylated maleates,
and acetylenic alcohols.

These acetylenic alcohols (cf. FR-B-1 528 464 and FR-A-2 372 874), which are among the preferred thermal blockers for the hydrosilylation reaction, have the formula:
R¹—(R²)C(OH)—C≡CH
in which formula,
R¹ is a linear or branched alkyl radical or a phenyl radical;
R² is H or a linear or branched alkyl radical or a phenyl radical;
   it being possible for the R¹ and R² radicals and the carbon atom situated α to the triple bond optionally to form a ring;
   the total number of carbon atoms present in R¹ and R² being at least 5, preferably from 9 to 20.

Said alcohols E are preferably chosen from those exhibiting a boiling point of greater than 250° C. Mention may be made, by way of examples, of:
1-ethynyl-1-cyclohexanol;
3-methyl-1-dodecyne-3-ol;
3,7,11-trimethyl-1-dodecyne-3-ol;
1,1-diphenyl-2-propyne-1-ol;
3-ethyl-6-ethyl-1-nonyne-3-ol;
3-methyl-1-pentadecyne-3-ol.

These α-acetylenic alcohols are commercial products.

Such a retardant E is present in a proportion of 3 000 ppm at the most, preferably in a proportion of 100 to 2 000 ppm, with respect to the total weight of the organopolysiloxanes (A) and (B).

The surfactant or surfactants (G) capable of being present in the emulsion according to the invention as emulsifying agent are nonionic or ionic in nature.

In practice, use may be made, as nonionics, of alkylphenols, fatty alcohols or fatty acids carrying alkylene oxide groups, for example ethylene or propylene oxide, e.g.: nonylphenol comprising between 9 and 30 ethylene oxide (EO) groups or oleic acid with 2 to 8 EO.

The ionic surfactants, preferably anionic surfactants, which can be employed are, e.g., sulfates, sulfonates, phosphates, sulfosuccinates, sulfosuccinamates, sulfoacetates or amino acid derivatives.

For further details regarding the available surfactants, reference will be made to the reference works, for example to the article which appeared in “Informations Chimie [Chemical Information], No. 146, June-July 1975, p. 119-126”.

As regards the water-soluble emulsifying agents -G- of protective colloid type, it should be observed that, in addition to their emulsifying function, these emulsifying agents -G- can also be active as promoters of antiadhesiveness, of water repellency, indeed even of printability, as regards the field of paper antiadhesiveness.

It is precisely the case of the poly(vinyl alcohol)s (PVAs) which can be employed as optional additive -H- in the context of the invention. Thus, the PVAs can act as emulsifiers -G- and as additives -H-.

Poly(vinyl alcohol)s (PVAs) -H- are compounds obtained indirectly from their esters by hydrolysis in aqueous medium or by alcoholysis in anhydrous medium. In practice, the esters used as starting material are commonly poly(vinyl acetate)s. The lysis of the esters resulting in the PVAs -H- is generally incomplete. Acyl radicals remain in the molecule, the proportion of which influences the properties of the PVA -H-, in particular its solubility. One form of definition of PVAs -H- is therefore based on the indication of the ester number (E.N.), which is inversely proportional to the degree of hydrolysis. The E.N. is measured in a way known per se, by neutralization of any acid present in the poly(vinyl alcohol), saponification of the acyl groups and titration of the excess from alkaline saponification.

The poly(vinyl alcohol)s -H- are also characterized by their degree of condensation, which can be evaluated by the determination of the dynamic viscosity of a typical solution (denoted by η_{dt} in the present account), it being known that this variable increases as the degree of condensation increases. The viscosity η_{dt} corresponds to the dynamic viscosity coefficient of a 4 weight % aqueous PVA solution measured at a temperature of 20±5° C. using a Brookfield viscometer.

The PVAs of use as emulsifier -G- and/or as additive -H- have a molar mass Mw<10⁵ g/mol. They are therefore PVAs, the viscosity η_{dt} of which is between 3 and 40 mPa·s, preferably between 5 and 30 mPa·s, and the degree of hydrolysis of which is between 60 and 100% by molecule, preferably between 75 and 90% by molecule.

The poly(vinyl acetate)s are conventional PVAs which can be used in the invention.

Furthermore, the emulsion according to the invention optionally comprises one or more additives I which can be, inter alia:

I₁=bactericidal agent, such as, for example, sorbic acid,

I₂=antigelling and/or wetting agent, such as, for example, glycols, such as propylene or ethylene glycol,

I₃=antifoam, advantageously selected from silicone antifoams, such as, for example, those sold by the Applicant Company under the name Rhodorsil® 70414, sold by Rhodia Silicones,

I₄=filler, preferably inorganic filler, chosen from siliceous or non-siliceous materials, siliceous fillers being more particularly preferred,

I₅=coadditives of synthetic latex type, in combination with the protective colloids H acting as emulsifiers and promoters of antiadhesiveness (PVAs); it being possible for these synthetic latices to be, for example, butadiene (co)polymers, acrylics, vinyl acetates, and the like;

I₆=dye or pigment;

I₇=acidifying agent, such as, for example, acetic acid.

As regards the siliceous fillers I₄, it should be noted that they can act as reinforcing or semi-reinforcing filler.

The reinforcing siliceous fillers are chosen from colloidal silicas, fumed and precipitation silica powders or their mixture.

These powders exhibit a mean particle size generally of less than 0.1 mm and a BET specific surface of greater than 50 m²/g, preferably of between 150 and 350 m²/g.

Semireinforcing siliceous fillers, such as diatomaceous earths or ground quartz, can also be employed.

As regards the nonsiliceous inorganic materials, they can be involved as semireinforcing inorganic filler or packing. Examples of these non-siliceous fillers which can be used alone or as a mixture are carbon black, titanium dioxide, aluminum oxide, hydrated alumina, expanded vermiculite, non-expanded vermiculite, calcium carbonate, zinc oxide, mica, talc, iron oxide, barium sulfate and slaked lime. These fillers have a particle size generally of between 0.001 and 300 mm and a BET surface of less than 100 m²/g.

As for weight, it is preferable to employ an amount of filler of between 20 and 50, preferably between 25 and 35, % by weight with respect to all the constituents of the composition.

According to an advantageous provision of the invention, the proportion of water in the emulsion is greater than or equal to 50% by weight, preferably greater than or equal to 55% by weight and, for example, in practice of the order of 55-60% by weight or of 85 to 90% by weight.

According to another of its aspects, the present invention relates to a process for the preparation of an aqueous silicone emulsion which can be used in particular as coating base for the preparation of antiadhesive and water-repellent coatings, this emulsion being of the type of that defined above.

According to a preferred characteristic of the invention, the hydrophilic polymer stabilizer is incorporated in the formulation before, during or after the formation of the aqueous silicone emulsion.

The preparation of an emulsion according to the invention can be a mixing of two preemulsions, namely a base preemulsion E₁ and a catalyzing preemulsion E₂, so as to produce an emulsion E₃ which may or may not be diluted with water so as to adjust the silicone content on a dry basis according to the targeted application (silicone deposit desired, type of substrate treated and coating technique).

As soon as there is available an emulsion E₃ which has or has not been prepared by the process described hereinabove and which exhibits the advantage of being subject neither to coalescence under shearing nor to foaming nor to gelling, it is particularly advantageous to be able to use it in applications for the manufacture of crosslinked silicone polymers and in particular of antiadhesive silicone coatings.

It follows that, according to another of its subject matters, the present invention relates to a process for preparing a coating, in particular an antiadhesive and water-repellent coating, on a fibrous or nonfibrous substrate, preferably made of paper, characterized in that it consists:
in coating the substrate with the emulsion described hereinabove and/or as obtained by the process described above,
and in seeing to it that the coated layer crosslinks by providing, preferably, thermal activation.

The coating is carried out according to known and appropriate means, for example with a doctor blade, with a size press roller, with an engraved cylinder or with a gate roll.

The means for thermal activation of the crosslinking are conventionally ovens (for example tunnel ovens), hot rollers, indeed even infrared sources. This thermal activation can be completed by actinic activation and/or by electron bombardment.

The coated substrates are preferably fibrous substrates and more preferably still substrates made of paper or the like. In this application, the degree of coating is less than or equal to 1.2 g of silicone/m² of substrate, preferably less than or equal to 0.9 g/m² and more preferably still less than or equal to 0.50 g/m².

Mention may be made, as other examples of substrates, of those composed of synthetic polymers, such as polyethylenes, polypropylenes or polyesters, or alternatively of natural polymer.

It is obvious that the substrates can be provided in any other form than that of sheet or film.

According to a favored application of the emulsion according to the invention, the fibrous or nonfibrous substrate comprises, on at least one of its faces, an antiadhesive and water-repellent (optionally printable) coating obtained by crosslinking said emulsion. More specifically, this substrate can comprise the antiadhesive and water-repellent coating on one of these faces and an adhesive coating on the opposite face. In this implementation, articles such as self-adhesive labels, sheets, tapes or the like which have the properties of being water repellent and printable and which can stick reversibly to one another are envisaged in particular. The latter characteristic is particularly advantageous for self-adhesive labels, as it makes it possible to dispense with conventional antiadhesive substrates.

It is obvious that the invention is not limited to substrates with opposite adhesive/antiadhesive faces. It also encompasses all substrates coated solely with a printable adhesive layer, which substrates can be printed and used as such, for example as protective means.

The examples which follow of the preparation of the silicone emulsion under consideration and of its application as antiadhesive and water-repellent coating for paper substrates will make possible a better understanding and grasp of the invention. They will also reveal the alternative forms and the advantages of said invention, the performance of which in terms of stability toward coalescence under shearing, in terms of evenness of silicone deposition on the faces and in terms of reduction in the dust will be underlined by comparative tests.

### DESCRIPTION OF THE FIGURES

FIG. 1 (example 2) shows curves giving the change in the particle size parameter D₅₀ (in μm) as a function of shearing time t (in hours) (T stability test) for two aqueous emulsions of silicone oil POE 1 and POE 3, to which emulsions polyoxyethylene (POE) has been added, and for a control silicone emulsion E 1.2 without POE;

FIG. 2 (example 2) shows curves giving the change in the particle size parameter D₅₀ (in μm) as a function of the shearing time t (in hours) (T stability test) for two emulsions of silicone oil POE 2 and POE 3; comprising POE 2 and POE 3 (0.08%) and poly(vinyl alcohol) (PVA: 1%), and for a control silicone emulsion E 1.2 without POE;

FIG. 3 (example 2) shows a curve (-◯-) giving the change in the mean diameter (Dm) in μm and a curve (-□-) giving the change in the median diameter (Dm) in μm as a function of the shearing time t (in hours) (T stability test) for an aqueous emulsion of silicone oil comprising 0.5 weight % of POE 3;

FIG. 4 (example 3) shows graphs giving the change in the mean diameter (Dm) in μm of the particles of dispersed phase as a function of the time t (in hours) for:
[-x-x-]: an aqueous emulsion of silicone oil comprising 1% of PVA (control);
[-⋄-⋄-]: an aqueous emulsion of silicone oil comprising 1% of PVA and polyacrylamide (PAM) FA 920 at a level of 0.5 weight %;
[-Δ-Δ-]: an aqueous emulsion of silicone oil comprising 1% of PVA and polyacrylamide (PAM) FA 920 at a level of 0.1 weight %;
[-◯-◯-]: an aqueous emulsion of silicone oil comprising 1% of PVA and polyacrylamide (PAM) FA 920 at a level of 0.01 weight %;

FIG. 5 (example 5) shows a curve (-◯-) giving the change in the mean diameter (Dm) in μm and a curve (-□-) giving the change in the median diameter (Dm) in μm as a function of the shearing time t (in hours) (T stability test) for an aqueous emulsion of silicone oil comprising 0.1 weight % of PAM FA 920 VHM;

FIG. 6 (example 4) shows a curve (-O-) giving the change of the mean diameter (Dm) in μm and a curve (-□-) giving the change in the median diameter (Dm) in μm as a function of the shearing time t (in hours) (T stability test) for an aqueous emulsion of silicone oil comprising 0.1 weight % of hydroxypropylguar.

### EXAMPLES

### Example 1

1.1 Materials

1. Emulsion E3, 300 g, i.e. of silicone “option 25”: the amount of emulsion used is 300 g, i.e.
   82.2 g of option 25, i.e. an emulsion E1.1 comprising approximately 1% of 25/88 PVA (poly(vinyl alcohol)) per ˜38% of copoly(dimethyl)(methylvinyl)siloxane silicone oil comprising dimethylvinylsilyl ends (Si-Vinyl oil) with an η_{dt} of 250 mPa·s and approximately 0.75-1 weight % of vinyl;
   2.9 g of emulsion E1.2 comprising 2% of 25/88 PVA and 30% of poly(methylhydro)siloxane silicone oil comprising trimethylsilyl ends (the SiH oil) with an η_{dt} of 30 mPa·s and approximately 30 weight % of Si—H functional groups;
   6 g of emulsion E2 comprising 2% of 25/88 PVA and 38% of polydimethylsiloxane silicone oil with an η_{dt} of 600 mPa·s and approximately 0.4 weight % of vinyl (279), this emulsion comprising a few ppm of platinum catalyst.

The remainder is deionized water.
2. Polymers in solution (stabilizer D):
   polyoxyethylene “POE”, sold by Union Carbide:
      POE 1, Polyox® “WSRN-12K”, Mw=1×10⁶ g/mol
      POE 2, Polyox® “WSR coagulant”,
      Mw=5×10⁶ g/mol
      POE 3, Polyox® “WSR-308”, Mw=8×10⁶ g/mol
   polyacrylamide (PAM) from American Cyanamide with the reference FA920 (Mw=8×10⁶ g/mol, η_{intrinsic}=1.3336) and with the reference FA920VHM (Mw≧9×10⁶).
   guars from Rhodia.
      1.2 Methods

Vortex measurement: A solution of 800 ml of water is stirred using a frame paddle with a width of 15 mm and a length of 30 mm in a 1 liter measuring cylinder. The rotational speed, approximately ˜900 rpm, is adjusted to allow the vortex in the water to reach a height of 75 mm with respect to the level of the water at rest.

The polymer introducing the elongational viscosity is added dropwise. The height of the vortex is measured after 20 seconds.

T stability test for evaluating the effect of the hydrophilic polymer stabilizer (POE, PAM and guars) on the coalescence under shearing of a base emulsion.

This stability test is carried out in a glass beaker with a diameter of 7.5 cm and a length of 13 cm, thermostatically controlled at 30° C. The paddle used is a propeller paddle (3 blades) with a diameter of 3 cm and is situated at a distance of 2 cm from the bottom of the beaker. The stirrer speed is 2 000 rpm. Every hour, a sample is withdrawn and the size of the emulsion is measured on an Horiba particle sizer.

Attachment test: The attachment of the silicone coating is evaluated using a trade test consisting in rubbing the silicone surface with the index finger (10 to-and-fro movements) and observing the appearance of dust at the surface.

No dust after 10 passes=excellent.

Dust after 8 passes=good

Dust before 8 passes=poor.

Reactivity test: The reactivity of a slip coating is evaluated by the level of crosslinking after 30 seconds at 110° C. in an oven. The trade test known as the loop test is used to characterize the level of crosslinking: adhesive-to-adhesive tackiness of a tape after contact with the silicone-treated surface.

Gloss: The gloss of the silicone layer is evaluated by a simple qualitative visual observation.

Wetting: This measures the ability of the slip to wet the substrate during manual coating carried out in the laboratory on a Meyer rod. It is observed visually whether there is dewetting of the coating before insertion in the oven for crosslinking.

### Example 2

### Polyoxyethylene

POE 1 and POE 3 are employed

2.1 The stability under shearing contributed to E1.1 by POE 1 and POE 3 (0.08%) is compared with respect to a reference emulsion E1.2 without POE.

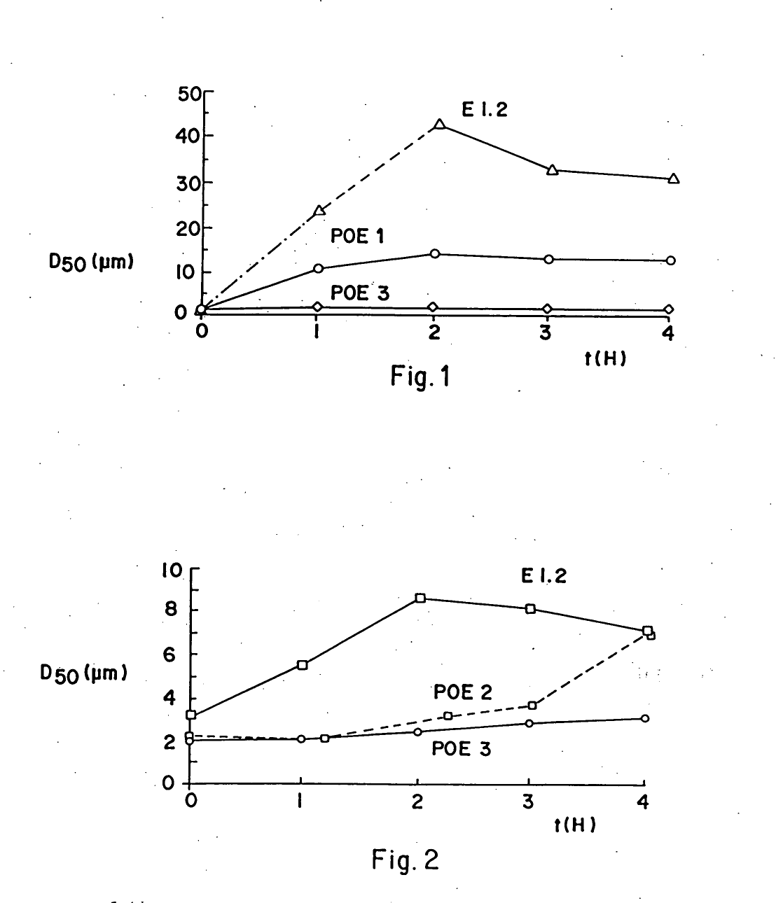

FIG. 1 represents a curve of the change in the D₅₀ as a function of the shearing time for POE 1 and POE 3 and ref. E1.2.

POE 2, with a greater mass, is more efficient in stabilizing the emulsion.

2.2 The stability under shearing of an emulsion E1.1 is compared using POE 1 and POE 2 at a content of 800 ppm.

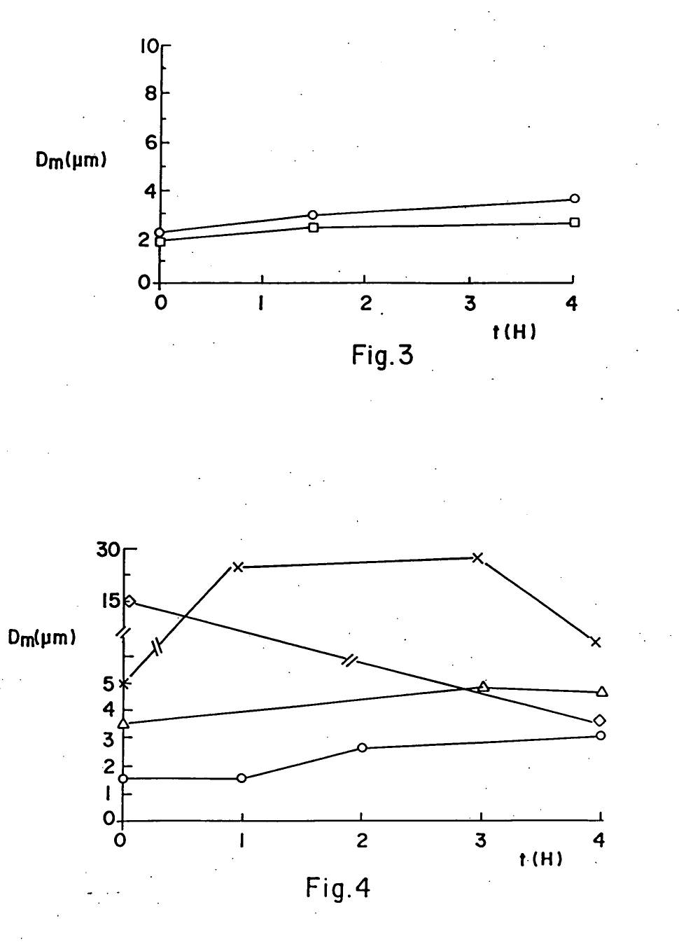

FIG. 2 represents the change in the D₅₀ as a function of the shearing time for emulsions with 1% of PVA comprising 0.08% of POE 2 and POE 3 and a reference emulsion E1.2 without POE.

The applicational properties (see Table 1) are very good, with the exception of a slight reduction in the gloss after shearing for 4 hours.

TABLE 1
Applicational properties of the emulsions stabilized with the polyoxyethylenes

| | |
|---|---|
| 0.08% POE 2 | 0.08% POE 3 |

| Hrs | Attachment | Reactivity | Gloss | Cobb | Wetting | Attachment | Reactivity | Gloss | Cobb | Wetting |
|---|---|---|---|---|---|---|---|---|---|---|
| 0 | ✓ | ✓ | ✓ | ✓ | ✓✓ | ✓ | ✓ | ✓ | ✓ | ✓✓ |
| 1 | ✓ | ✓ | ✓ | ✓ | ✓✓ | ✓ | ✓ | ✓ | ✓ | ✓✓ |
| 2 | ✓ | ✓ | ✓ | ✓ | ✓✓ | ✓ | ✓ | ✓ | ✓ | ✓✓ |
| 3 | ✓ | ✓ | ✓ | ✓ | ✓✓ | ✓ | ✓ | ✓ | ✓ | ✓✓ |
| 4 | ✓ | ✓ | mod. | ✓ | ✓✓ | ✓ | ✓ | mod. | ✓ | ✓✓ |

Key: ✓ = good, ✓✓ = very good, mod. = moderate

POEs of Low Mass

The POEs of “low” mass do not develop elongational viscosity but exhibit a normal viscosity similar to the POEs of high mass.

A POE 3 with an Mw of 300 K is employed at a concentration of 0.5% by weight in an emulsion E1.1.

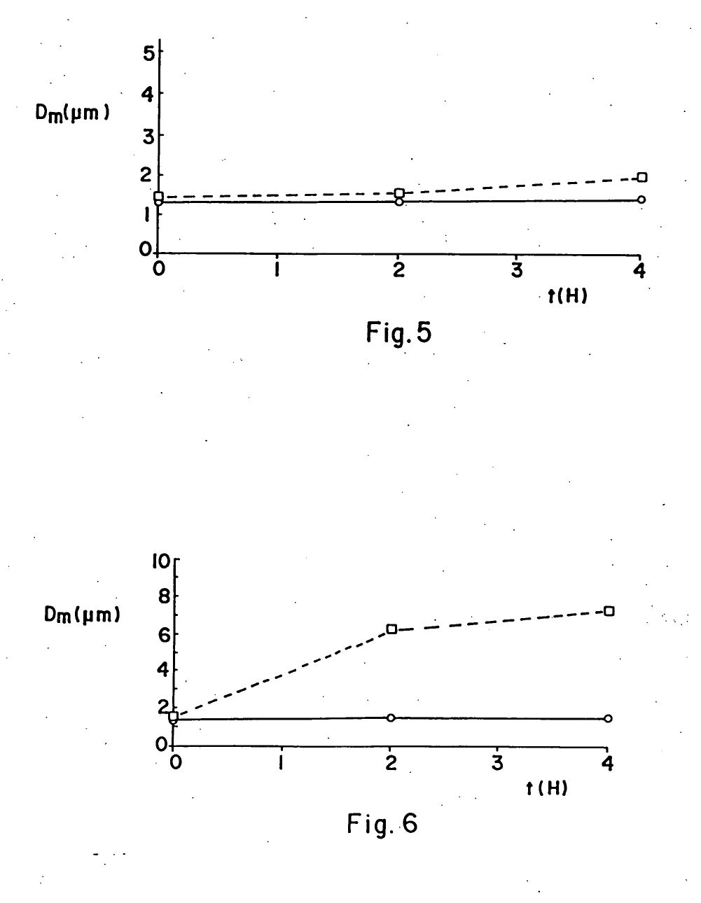

FIG. 3 shows that the emulsion to which 0.5% of POE 3 had been added has an increased stability. Nevertheless, the applicational properties are poor, see Table 2 below.

TABLE 2
Applicational properties of the emulsions stabilized with the low-mass poly(ethylene oxide)s

| | 0.08% POE 3 (300 K) | | | | | | 0.5% POE 3 (300 K) | | | | |
|---|---|---|---|---|---|---|---|---|---|---|---|
| Hrs | Attachment | Reactivity | Gloss | Cobb | Wetting | Hrs | Attachment | Reactivity | Gloss | Cobb | Wetting |
| 0 | ✓ | ✓ | ✓ | | ✓ | 1 | ✓ | ✓ | ✓ | | mod. |
| 1 | x | x | x | | ✓ | 1.5 | ✓ | mod. | x | | mod. |
| 4 | x | x | x | | mod. | 4 | ✓ | ✓ | x | | mod. |

mod. = moderate

It may be concluded, on the basis of the above results, that the stability under shearing of the antiadhesive paper emulsion is obtained by use of polymers of high masses which develop an elongational viscosity.

### Example 3

### Polyacrylamide

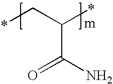

Polyacrylamides (PAMs) of high molecular mass can also be used in accordance with the invention.

PAMs are employed at different concentrations in an emulsion E1.1. The reference used is Floerger FA920 from SNF.

These emulsions, with or without the addition of PAM, are subjected to the T stability test.

FIG. 4 represents the change in the coalescence under shearing of an emulsion based on ˜1% of of PVA (φ=40%, D₅₀˜1.5 μm) comprising from 100 to 5 000 ppm of the polyacrylamide Floerger FA920.

FIG. 4 shows that PAM FA920 (mass 8×10⁶) at a level of 0.01% stabilizes the emulsion and destabilizes it at a higher concentration. In addition, at t=0, there is an initial flocculation (by depletion), which explains the variation in initial size. It is observed that the addition of 0.5% of PAM reversibly flocculates the emulsion, at the beginning D₅₀˜15 μm and, at t=4 hours, D₅₀˜3.5 m.

FIG. 5 represents the stabilization under shearing of an emulsion based on ˜1% of PVA (φ=40%, D₅₀˜1.3 μm) comprising 1 000 ppm of the polyacrylamide Floerger FA920 VHM (Mw≧8×10⁶).

FIG. 5 shows the increased stabilization introduced by using a PAM of “very” high molecular mass. Virtually perfect stabilization is observed at 0.1%.

Table 3 exhibits the applicational properties observed for the PAMs: all these evaluations are good, in particular the adhesion and the reactivity, and in particular the PAM of very high mass exhibits very good wetting of the substrate. The PAM with the highest mass is therefore shown to be the most effective, just like the POE.

TABLE 3
Applicational properties of the emulsions stabilized with the polyacrylamides

| | 0.1% PAM (FA920) | | | | | 0.1% PAM (FA920VHM) | | | | |
|---|---|---|---|---|---|---|---|---|---|---|
| Hrs | Attachment | Reactivity | Gloss | Cobb | Wetting | Attachment | Reactivity | Gloss | Cobb | Wetting |
| 0 | ✓ | ✓ | ✓ | | ✓ | ✓ | ✓ | ✓ | | ✓✓ |
| 2 | ✓ | ✓ | ✓ | | ✓ | ✓ | ✓ | ✓ | | ✓✓ |
| 4 | ✓ | ✓ | mod. | | ✓ | ✓ | ✓ | ✓ | | ✓✓ |

mod. = moderate

### Example 4

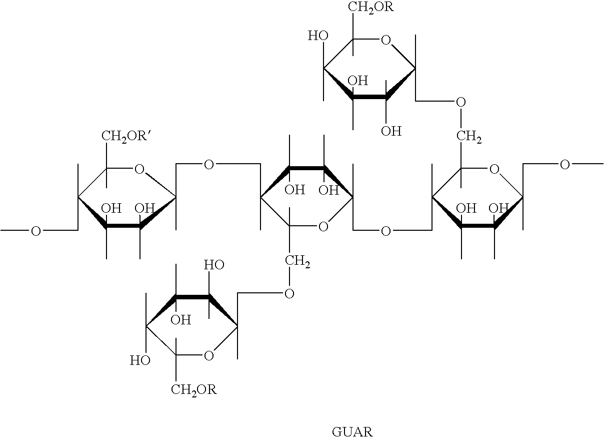

The guars constitute the third type of polymer evaluated. These are β-1,4-polysaccharides composed of a mannose backbone with pendent galactoses. The galactose/mannose ratio is 2/1.

The guar HP105 is a hydroxypropylated guar with a mass of ˜600 K with a degree of substitution of ˜0.6.

An emulsion E1.1 stabilized with 0.1% of hydroxypropylguar HP105 is employed.

The reference used is E1.1 without guar.

The mean diameter of the emulsion stabilized with HP105 guar increases under shearing: see FIG. 6, which represents the mean change in mean size of an emulsion E1.1 stabilized with 0.1% of hydroxypropylguar HP105.

Table 4 below gives the applicational properties of the emulsion to which guar has been added described above.

TABLE 4
Applicational properties of the emulsions stabilized with
hydroxypropylguar HP 105

| | 0.1% HP GUAR 105 | | | | |
|---|---|---|---|---|---|
| Hrs | Attachment | Reactivity | Gloss | Cobb | Wetting |
| 0 | ✓ | ✓ | ✓ | | ✓ |
| 2 | ✓ | ✓ | ✓ | | ✓ |
| 4 | ✓ | ✓ | ✓ | | ✓ |

The HP105 guar satisfactorily stabilizes the emulsion, just like POE 2.

### Example 5

This example compares the performance of a silicone emulsion formulation comprising poly(ethylene oxide) in comparison with a formulation comprising hydroxyethylcellulose as thickening agent.

The formulations are prepared from the same silicone emulsions:
Silcolease 902 (Rhodia): emulsion formed from a mixture of vinylated PDMS oil and hydrogenated PDMS oil comprising approximately 40% on a dry basis of silicone.
Silcolease 903 (Rhodia): catalyzing emulsion with Pt (vinylated PDMS oil plus Pt complex) comprising approximately 40% on a dry basis of silicone.

These emulsions will be formulated in postaddition (but this could be carried out at the time of the emulsification of the silicone oils), according to the circumstances, with:
HEC 250H from Hercules, as thickener,
POE WSR 308 from Union Carbide (molar mass 8×10⁶ g/mol) and POE WSR coagulant from Union Carbide (mass 5×10⁶ g/mol).

The foam and the dust (deposits on the drying rolls of the coating line) are evaluated visually during the test and at the end of the test.

The compositions of the 3 formulations employed are given in table 5 below.

TABLE 5
Formulations employed

| | 1 | 2 | 3 |
|---|---|---|---|
| Silcolease | 100 | 100 | 100 |
| 902 | | | |
| Silcolease | 12 | 12 | 12 |
| 903 | | | |
| POE 8 × 10⁶ | 2.9 | | |
| POE 5 × 10⁶ | | 2.9 | |
| HEC | | | 0.71 |
| Water | 250 | 250 | 250 |

The results obtained with these various formulations are summarized in the following table 6:

TABLE 6

| | | D50 | D90 | Deposit | Deposit | Evaluation |
|---|---|---|---|---|---|---|
| | D50 | After 4 | after 4 | Face 1 | Face 2 | Dust after |
| Formulation | Initial | hours | hours | g/m² | g/m² | 4 hours |
| 1 | 0.8 μm | 1 μm | | 0.47 | 0.48 | Good |
| 2 | 0.8 μm | 12 μm | | — | — | — |
| 3 | 0.8 μm | 33 μm | | 0.5 | 0.36 | Poor |

They demonstrate:
the stability toward coalescence under shearing contributed by the POE, which stability increases as the mass of the polymer increases (T stability test described above);
the evenness and the homogeneity of the silicone deposits, measured in g/m² by the X-ray fluorescence method on an Oxford X-ray 3 000 device), on the two faces of the paper: these deposits were obtained after coating on a size press and crosslinking at 130° C. on a nonporous vegetable parchment substrate;
the reduction in the dust (silicone deposits), which dust is evaluated visually on the rollers of the equipment after coating;
the elimination of foam.

1-9. (canceled)

10. A process for preparing an antiadhesive and water-repellent coating on a flexible substrate, said process comprising:
coating a flexible substrate with an aqueous silicone emulsion, using coating equipment having rollers, to produce an antiadhesive and water-repellent coating, wherein said aqueous silicone emulsion comprises silicone particles, said silicone particles comprising a crosslinkable silicone capable of crosslinking to form the antiadhesive coating, said emulsion having a limited tendency to foam, while reducing residual deposits of silicone on the rollers of the coating equipment resulting from the aqueous silicone emulsion;
wherein said emulsion also contains an additive stabilizer selected so that the emulsion has the following particle size characteristics regarding the dispersed silicone phase:
a starting particle size such that:
D₅₀≦0.7 μm
D₉₀≦1.5 μm
a particle size after 4 hours in a T stability test such that:
D₅₀≦7 μm,
D₉₀≦20 μm,
D₅₀=diameter below which lies at least 50% of the population of particles and
D₉₀=diameter below which lies at least 90% of the population of particles; and
crosslinking the coating.

11. The process of claim 10, wherein said additive stabilizer is at least one member selected from the group consisting of
an aliphatic polyether obtained from monomers comprising at least one linear or branched alkylene residue having from 1 to 6 carbon atoms;
a (co)polyacrylamide obtained by copolymerization of acrylamide with one copolymerizable comonomer(s);
a polysaccharide of animal, vegetable or bacterial origin; and
a polyacrylate having the formula: 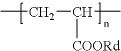
with Rd being a liner or branched C₁-C₁₂ alkyl or a C₅-C₆ cycloalkyl.

12. The process of claim 10, wherein said additive stabilizer is an aliphatic polyether selected from the group consisting of poly(methylene oxide), poly(ethylene oxide), poly(propylene oxide), copoly(methylene oxide) (propylene oxide) and polyoxethane.

13. The process of claim 10, wherein said additive stabilizer is a polysaccharide selected from the group consisting of chitosan, chitin, a carrageenan, an alginate, arabic gum, guar gum, locust bean gum, tara gum, cassia gum, konjac gum, mannan gum, cellulose, carboxy-methylcellulose, methylcellulose, ethylcellulose, hydroxymethylcellulose, starch, cyanoethylated starch, carboxy-methylated starch, a biogum obtained by fermentation of a carbohydrate under the action of a microorganism.

14. The process of claim 13, wherein said biogum is an xanthan gum obtained by fermentation under the action of a microorganism belonging to the Xanthomonas genus.

15. The process of claim 10, wherein said additive stabilizer is selected from the group consisting of an aliphatic polyether and a (co)polyacylamide, said hydrophilic (co)polymer having a molecular weight of at least 1×10⁶ g/mol, and wherein the concentration Cs, expressed as weight % with respect to the mass of polyorganosiloxane in the emulsion, is 0.1≦Cs≦5.

16. The process of claim 15, wherein said additive stabilizer has a molecular weight (Mw) of 20×10⁶≧Mw≧4×10⁶ g/mol, and wherein the concentration Cs is 0.5≦Cs≦2.

17. The process of claim 10, wherein the emulsion further comprises at least one poly(vinyl alcohol) (PVA), the dynamic viscosity η_{dt} of which is between 5 and 40 mPa·s and the degree of hydrolysis of which is between 85 and 98.

18. The process of claim 17, wherein the degree of hydrolysis of said poly(vinyl alcohol) is between 89 and 95.

19. The process of claim 10, wherein said coated layer is crosslinked by providing thermal activation.

20. The process of claim 10, further comprising coating said substrate on another face.

21. In a process for preparing an antiadhesive and water-repellent coating on a flexible substrate,
in which an aqueous silicone emulsion is coated upon a flexible substrate using coating equipment having rollers to produce a coating which is then crosslinked,
in which said aqueous silicone emulsion comprises silicone particles and an additive stabilizer, said silicone particles comprising a crosslinkable silicone capable of crosslinking to form the antiadhesive coating,
the improvement comprising selection of said additive stabilizer such that:
(a) the emulsion has the following particle size characteristics:
a starting particle size such that:
D₅₀≦0.7 μm
D₉₀≦1.5 μm
and a particle size after 4 hours in a T stability test such that:
D₅₀≦7 μm,
D₉₀≦20 μm,
wherein
D₅₀=diameter below which lies at least 50% of the population of particles, and
D₉₀=diameter below which lies at least 90% of the population of particles, and
(b) residual deposits of silicone on the rollers of the coating equipment resulting from the aqueous silicone emulsion are reduced.
